(19) United States
(12) Patent Application Publication
(10) Pub. No.: US 2017/0225585 A1
(43) Pub. Date: Aug. 10, 2017

(54) BATTERY PACK AND POWER SUPPLY SYSTEM FOR VEHICLE

(71) Applicant: YAZAKI CORPORATION, Tokyo (JP)

(72) Inventor: Tsutomu Saigo, Shizuoka (JP)

(21) Appl. No.: 15/423,097

(22) Filed: Feb. 2, 2017

(30) Foreign Application Priority Data
Feb. 4, 2016 (JP) 2016-019366

(51) Int. Cl. B60L 11/18; H01M 10/48; H01M 10/6563; H01M 10/613; H01M 10/625; H01M 2/10; H01M 10/42

(52) U.S. Cl. CPC B60L 11/1864; B60L 11/1874; H01M 2/1077; H01M 10/486; H01M 10/425; H01M 10/613; H01M 10/625; H01M 10/6563; H01M 2220/20

(57) ABSTRACT

A battery pack includes a high-voltage battery which includes a plurality of unit cells which are connected, a step-down circuit which is disposed between the high-voltage battery and a load, and steps-down voltage applied from the high-voltage battery, a control unit which executes step-down control so that the step-down circuit performs the step-down, and a casing which accommodates the high-voltage battery and the step-down circuit and the control unit.

### CROSS-REFERENCES TO RELATED APPLICATION

This application is based on and claims priority from Japanese Patent Application Nos. 2016-019366 filed on Feb. 4, 2015, the entire contents of which are incorporated herein by reference.

### BACKGROUND OF THE INVENTION

Field of the Invention

The present invention relates to a battery pack and a power supply system for a vehicle.

Description of Related Art

There has been proposed a power supply system for a vehicle which includes, for example, a high-voltage battery, high-voltage loads (e.g., motor for travelling) driven by electric power supplied from the high-voltage battery, a DC/DC converter for stepping down voltage applied from the high-voltage battery, and low-voltage loads (e.g., auxiliary devices) driven by electric power stepped down by the DC/DC converter (see Patent Literature 1, for example). As such the system includes the DC/DC converter, both the high-voltage loads and the low-voltage loads can be driven by electric power supplied from the high-voltage battery.

### [Patent Literature 1] JP-A-2013-241068

According to a related art, in a system where a DC/DC converter is disposed away from a high-voltage battery, a fluctuation amount of input voltage to the DC/DC converter becomes large depending on electric power consumption on a low-voltage load side. Thus it is difficult to step the voltage down to a suitable value.

The invention, having been contrived in order to solve the heretofore described problem of the related art, has for its object to provide a battery pack and a power supply system for a vehicle which can suitably step-down voltage applied from a high-voltage battery.

### SUMMARY

One or more embodiments provide a battery pack which includes a high-voltage battery which includes a plurality of unit cells which are connected; a high-voltage battery which includes a plurality of unit cells which are connected, and steps-down voltage applied from the high-voltage battery; a control unit which executes step-down control so that the step-down circuit performs the step-down, and a casing which accommodates the high-voltage battery, the step-down circuit and the control unit.

In accordance with one or more embodiments, the high-voltage battery and the step-down circuit are installed in the same casing, that is, disposed at positions relatively close to each other. Thus, as compared with a case where the high-voltage battery and the step-down circuit are disposed away from each other like a situation that only one of them is disposed within the casing, a fluctuation amount of the voltage depending on electric power consumption of the load becomes small, and thus the step-down operation can be performed more stably.

In the battery pack of one or more embodiments, preferably, the battery pack further includes a sensor which detects at least one of voltage and temperature of the high-voltage battery and which is disposed in the casing, wherein the control unit monitors the high-voltage battery based on a signal from the sensor and adjusts the step-down control based on the signal from the sensor.

According to this battery pack, a sensor or the like is often provided in order to perform battery monitoring such as failure detection with respect to the high-voltage battery, and the step-down control is adjusted using such the sensor or the like. Thus, the step-down operation can be performed suitably according to a state of the high-voltage battery by utilizing the signal from the sensor for monitoring.

In the battery pack of one or more embodiments, preferably, the battery pack further includes a switch module which electrically conducts or interrupts between the high-voltage battery and the load and which is disposed between the high-voltage battery and the load in the casing, wherein the control unit executes drive control so as to perform the conduction or interruption at the switch module.

According to this battery pack, the switch module is also provided within the casing and the conduction and interruption control is performed. Thus, electrical connection control between the high-voltage battery and the load can also be performed within the battery pack.

In the battery pack of one or more embodiments, preferably, the control unit is formed of a single microcomputer.

According to this battery pack, as the control unit is formed of the single microcomputer, there does not arise such a necessity of providing a single microcomputer for each of the functions. The battery pack can thus be miniaturized entirely by integrating the various functions of the battery pack into the single microcomputer.

In the battery pack of one or more embodiments, preferably, the battery pack further includes a fan which can blow air and which is disposed in the casing and, wherein the casing includes openings at wall parts which are respectively on both end sides in a direction coupling an installation position of the high-voltage battery and an installation position of the step-down circuit, and the fan is disposed between the high-voltage battery and one of the openings closer to the high-voltage battery in the casing and blows the air toward the other opening side.

According to this battery pack, the openings are respectively formed at the wall parts on both the end sides of the casing in the direction coupling the installation position of the high-voltage battery and the installation position of the step-down circuit, and the fan is provided between the high-voltage battery and the opening closer to the high-voltage battery within the casing. Thus, air can be flown from the high-voltage battery side to the step-down circuit side via the openings at the wall parts on both the end sides, and hence the components within the casing can be cooled. Further, as the fan is provided between the high-voltage battery and the opening closer to the high-voltage battery, the high-voltage battery weak against heat is cooled preferentially. Consequently, the components within the casing can be cooled efficiently.

In the battery pack of one or more embodiments, preferably, the battery pack further includes shutter members which close or open the openings at the wall parts on both the end sides of the casing, respectively.

According to this battery pack, there are further provided with the shutter members which close or open the openings formed at the wall parts on both the end sides of the casing, respectively. Thus, when the openings are covered by the shutter members, air within the casing can be circulated by the fan. As a result, heat generated from the step-down circuit having a large amount of heat generation can be transferred to the high-voltage battery side. Consequently, under environment where the high-voltage battery is too cooled, the high-voltage battery can be warmed and hence the battery can be driven more efficiently.

In accordance with one or more embodiments, a power supply system for a vehicle includes: the battery pack; and a power-supply system control unit which transmits a signal to set the switch module to be conductive or interruptive to the control unit in the battery pack.

In the power supply system for a vehicle of one or more embodiments, the power supply system includes the battery pack and the power-supply system control unit which transmits at least the signal representing whether the switch module is to be placed in the conduction state or the interruption state to the control unit within the battery pack. In the related art, even if the battery pack contains therein the switch module which electrically conducts or interrupts between the battery and the load, the switch module is controlled by an ECU or the like provided outside the battery pack. Thus, when design of the switch module is changed, it is also required to change design of the external ECU or the like as well as the battery pack. In contrast, according to the aforesaid description, the switch module is controlled by the control unit within the battery pack, and the power-supply system control unit itself is merely configured to transmit only the signal representing the conduction state or the interruption state to be placed. Thus, even if design of the switch module is changed, only design of the control unit is required to be changed but design of the external power-supply system control unit is not required to be changed. Accordingly, the power supply system 1 for a vehicle more excellent in versatility can be provided.

According to one or more embodiments, the battery pack and the power supply system for a vehicle that can suitably step-down voltage applied from the high-voltage battery can be provided.

### BRIEF DESCRIPTION OF THE DRAWINGS

FIG. 1 is a block diagram illustrating a power supply system for a vehicle according to an embodiment.

FIG. 2 is a diagram illustrating internal structure of a battery pack shown in FIG. 1.

FIG. 3 is a diagram illustrating configuration arrangement within a battery pack according to a second embodiment.

FIG. 4 is a diagram illustrating a second configuration arrangement within the battery pack according to the second embodiment.

### DETAILED DESCRIPTION

Hereinafter, preferred embodiments according to the invention will be explained. The invention is not limited to embodiments described below and can be suitably changed within a range not departing from gist of the invention. In the embodiments described below, although part of configurations is omitted in its illustration and explanation, it goes without saying that known or well-known technique can be applied to details of the omitted technique within a range not contradictory to contents explained below.

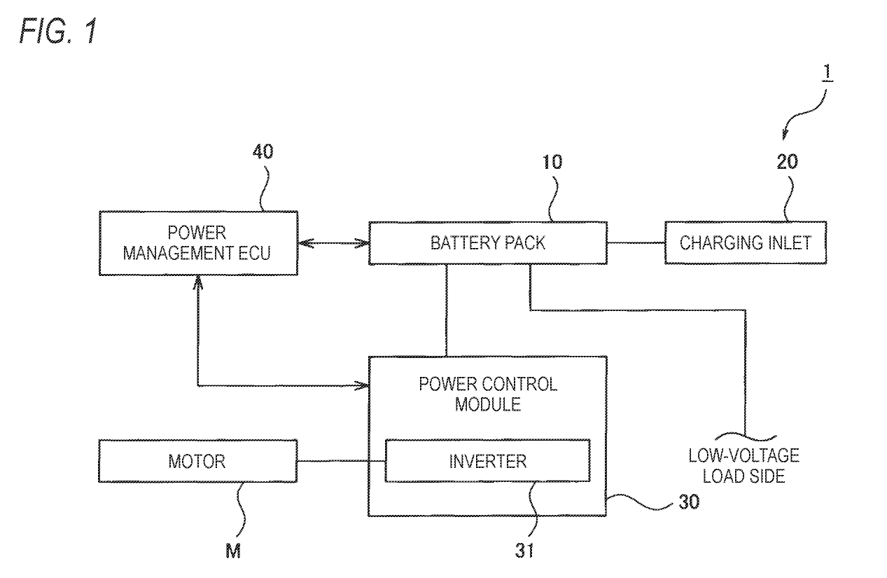

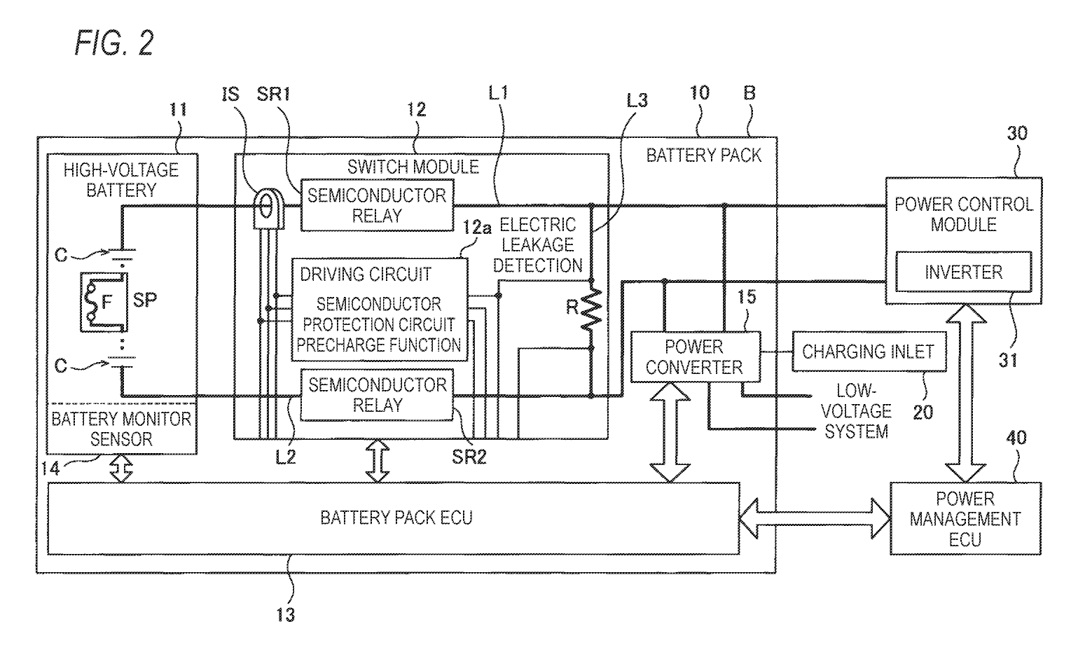

FIG. 1 is a block diagram illustrating a power supply system for a vehicle according to the embodiment. FIG. 2 is a diagram illustrating internal structure of a battery pack shown in FIG. 1. As shown in FIG. 1, a power supply system 1 for a vehicle according to the embodiment is configured to include a battery pack 10, a charging inlet 20, a power control module 30 and a power management ECU (power-supply system control unit) 40, and to connect these components via wiring.

As shown in FIG. 2, the battery pack 10 includes a high-voltage battery 11, a switch module 12, a battery pack ECU (control unit) 13 and a casing B which accommodates these components. The high-voltage battery 11 is formed by connecting a plurality of unit cells C. The switch module 12 is disposed between the high-voltage battery 11 and loads (high-voltage loads and low-voltage loads) and performs conduction or interruption therebetween. The battery pack ECU 13 executes drive control (first function) for causing the switch module 12 to perform the conduction or interruption, and is formed of a single microcomputer.

The charging inlet 20 shown in FIG. 1 is a connection section into which a charge connector is inserted. The charge inlet supplies electric power, supplied thereto in the insertion state of the charge inlet, to the battery pack 10 side. The power control module 30 controls driving of the high-voltage loads and includes, an inverter 31 for deriving a motor M, and so on in this embodiment.

The power management ECU 40 serves to control entirety of the power supply system and performs transmission and reception of a signal with the power control module 30. In this embodiment, the power management ECU 40 transmits at least a signal, representing whether the switch module 12 is to be placed in a conduction state or an interruption state, to the battery pack ECU 13. The battery pack ECU 13 receives this signal as input and executes the drive control for causing the switch module 12 to perform the conduction or interruption

Next, the battery pack 10 will be explained in detail.

The high-voltage battery 11 shown in FIG. 2 has a service plug SP, and is configured to be able to safely perform a work such as an inspection of the high-voltage battery 11 when the service plug SP is pulled out. The service plug SP has a fuse F and is configured to meltdown the fuse F upon generation of an abnormal current.

The switch module 12 includes a high-voltage side line L1 and a low-voltage side line L2 each connected to the high-voltage battery 11, semiconductor relays SR1 and SR2 respectively provided at the lines L1 and L2, and a driving circuit 12a for turning the semiconductor relays SR1 and SR2 on and off. Each side of the lines L1 and L2 opposite the high-voltage battery 11 is connected to the load side. Each of the semiconductor relays SR1 and SR2 is turned on and off by the battery pack ECU 13 via the driving circuit 12a. Thus, the switch module 12 changes its state between the conduction state and the interruption state for conducting and interrupting between the high-voltage battery 11 and the loads. Each of the semiconductor relays SR1 and SR2 is turned on and off based on the signal from the power management ECU 40.

The switch module 12 includes a current sensor IS. The driving circuit 12a has a semiconductor protection circuit and a precharge function. Thus, in the switch module 12, each of the semiconductor relays SR1 and SR2 is protected. Also, the switch module is protected from a rush current upon turning-on of each of the semiconductor relays SR1 and SR2.

The switch module 12 further includes a connection line L3, for connecting between the high-voltage side line L1 and the low-voltage side line L2 on a rear stage side (load side) of the semiconductor relays SR1 and SR2, and a resistor R provided on the connection line L3. The battery pack ECU 13 detects a voltage across the resistor R.

In addition, the battery pack 10 shown in FIG. 2 contains a battery monitor sensor (sensor) 14 and a power converter (step-down circuit) 15 within the casing B. The battery monitor sensor 14 detects a voltage and a temperature of the high-voltage battery 11 and transmits a signal according to the voltage and temperature to the battery pack ECU 13. The battery monitor sensor 14 may detect only one of the voltage and temperature.

The power converter 15 is disposed between the high-voltage battery 11 and the loads (in particular, on a rear stage side of the switch module 12) and steps down the voltage applied from the high-voltage battery 11. That is, in this embodiment, the step-down circuit such as a DC/DC converter is housed within the battery pack 10.

The battery pack ECU 13 further includes second to fourth functions in addition to the first function. The second function is a function for monitoring the high-voltage battery 11 according to the signal from the battery monitor sensor 14, that is, a function for determining a failure, etc., of the high-voltage battery 11 according to the signal from the battery monitor sensor 14.

The third function is a function for executing step-down control for performing the step-down in the power converter 15. The power converter 15 includes, e.g. an insulation transformer, etc., such that the battery pack ECU 13 controls energization to a primary side of the transformer and thus a stepped-down voltage is obtained from a secondary side thereof. Further, in the third function, the step-down control is adjusted according to the signal from the battery monitor sensor 14, that is, according to the monitoring result of the second function. As an example, the battery pack ECU 13 controls, for example, the energization to the primary side of the transformer so that a suitable output voltage is obtained in such a case where an input voltage to the power converter 15 reduces due to reduction of the voltage of the high-voltage battery 11.

The fourth function is a function for executing charge control when the charge connector is inserted into the charging inlet 20 and power is fed. There are cases where current supplied from the charge connector is DC and AC. In a case of DC, the supplied current is converted into a suitable charge voltage by DC/DC conversion and both the semiconductor relays SR1 and SR2 are turned on to charge the high-voltage battery 11. In a case of AC, the supplied current is converted into the suitable charge voltage by AC/DC conversion and both the semiconductor relays SR1 and SR2 are turned on to charge the high-voltage battery 11.

Next, an operation of the power supply system 1 for a vehicle according to the embodiment will be explained. Firstly, in such a case where the vehicle travels, when an auxiliary machine, etc., (low-voltage loads) as well as the high-voltage loads such as a motor M become objects to be driven, the power management ECU 40 determines that the switch module 12 is to be placed in the conduction state and transmits a signal (first signal) representing the determination. Further, the power management ECU 40 transmits a signal (second signal) representing that the low-voltage loads are also to be driven.

The battery pack ECU 13 receives the first and second signals as input. The battery pack ECU 13 exerts the first function in response to the reception of the first and second signals. That is, the battery pack ECU 13 turns the semiconductor relays SR1 and SR2 on to place the switch module 12 in the conduction state. Further, the battery pack ECU 13 exerts the third function in response to the reception of the second signal. That is, the battery pack ECU 13 controls the power converter 15 to perform a step-down operation. In this case, as the battery pack ECU 13 monitors the high-voltage battery 11 based on the signal from the battery monitor sensor 14 (second function), the battery pack ECU adjusts the step-down control based on the monitoring result.

Further, the battery pack ECU 13 receives a signal from the sensor IS within the switch module 12, and also monitors a terminal voltage across the resistor R to detect electric leakage between the high-voltage side line L1 and the low-voltage side line L2.

In contrast, if the charge connector is inserted into the charging inlet 20, for example, at a stopping state of the vehicle, the battery pack ECU 13 exerts the fourth function. That is, the battery pack ECU 13 controls the power converter 15 to perform the DC/DC conversion or the AC/DC conversion, and also turns the semiconductor relays SR1 and SR2 on to place the switch module 12 in the conduction state. The high-voltage battery 11 is therefore charged suitably.

In this manner, in the battery pack 10 according to the first embodiment, both the power converter 15 containing the step-down circuit and the high-voltage battery 11 are installed in the same casing B, that is, disposed at positions relatively close to each other. Thus, as compared with a case where the high-voltage battery and the power converter are disposed away from each other like a situation that only one of them is disposed within the casing, a fluctuation amount of the voltage depending on electric power consumption of the loads becomes small, and thus the step-down operation can be performed more stably.

A sensor or the like is often provided in order to perform battery monitoring such as failure detection with respect to the high-voltage battery 11. As the step-down control is adjusted using such the sensor 14, the step-down operation can be performed suitably according to a state of the high-voltage battery 11 by utilizing the signal from the battery monitor sensor 14 for monitoring.

The switch module 12 is also provided within the casing B and the conduction and interruption control is performed. Thus, electrical connection control between the high-voltage battery 11 and the loads can also be performed within the battery pack 10.

As the battery pack ECU 13 is formed of the single microcomputer, there does not arise such a necessity of providing a single microcomputer for each of the functions. The battery pack can thus be miniaturized entirely by integrating the various functions of the battery pack 10 into the single microcomputer.

Further, the power supply system 1 for a vehicle according to the embodiment includes the battery pack 10 and the power management ECU 40 which transmits at least the signal, representing whether the switch module 12 is to be placed in the conduction state or the interruption state, to the battery pack ECU 13 within the battery pack 10. In the related art, even if the battery pack 10 contains therein the switch module 12 which electrically conducts or interrupts between the battery 11 and the loads, the switch module 12 is controlled by an ECU or the like provided outside the battery pack 10. Thus, when design of the switch module 12 is changed, it is also required to change design of the external ECU or the like as well as the battery pack 10. In contrast, according to the aforesaid description, the switch module 12 is controlled by the battery pack ECU 13 within the battery pack 10, and the power management ECU 40 itself is merely configured to transmit only the signal representing the conduction state or the interruption state to be placed. Thus, even if design of the switch module 12 is changed, only design of the battery pack ECU 13 is required to be changed but design of the external power management ECU 40 is not required to be changed. Accordingly, the power supply system 1 for a vehicle more excellent in versatility can be provided.

Next, a second embodiment according to the invention will be explained. In the second embodiment, although a battery pack 10 and a power supply system for a vehicle are the same as those of the first embodiment, some configurations, etc., are added to the first embodiment. Hereinafter, explanation will be made mainly concerning contents added to the first embodiment.

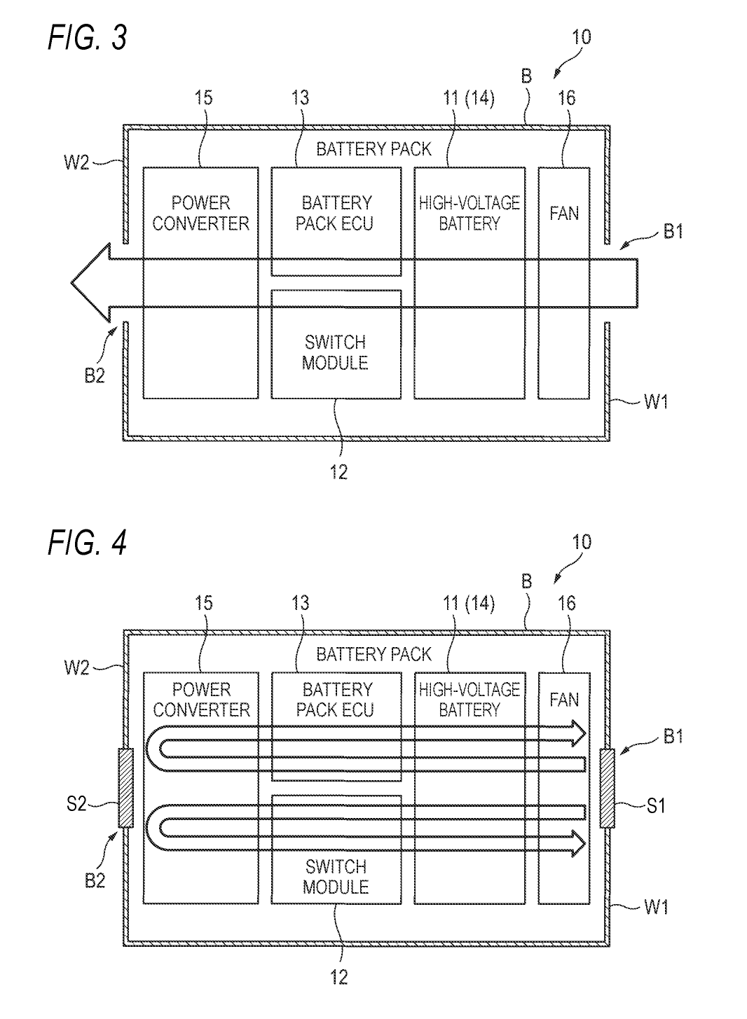

FIG. 3 is a diagram illustrating configuration arrangement within the battery pack 10 according to the second embodiment. As shown in FIG. 3, the battery pack 10 according to the second embodiment includes a fan 16 within a casing B. The fan 16 is a device that can blow air.

In the second embodiment, a high-voltage battery 11 is provided in adjacent to a blowing side of the fan 16. A switch module 12 and a battery pack ECU 13 are provided on one side of the high-voltage battery 11 opposite the fan 16. Further, a power converter 15 is provided on one sides of the switch module 12 and the battery pack ECU 13 opposite the fan 16. Thus, in the battery pack 10, the fan 16, the high-voltage battery 11, the switch module 12 and the battery pack ECU 13, and the power converter 15 are arranged in this order.

Further, in the second embodiment, two openings B1 and B2 are formed at the casing B of the battery pack 10. The two openings B1 and B2 are respectively formed at wall parts W1 and W2 on both end sides in a direction coupling an installation position of the high-voltage battery 11 and an installation position of the power converter 15.

The fan 16 is provided between the high-voltage battery 11 and the opening B1 closer to the high-voltage battery 11 within the casing B and is configured to blow air toward the other opening B2 side. Thus, ambient air is taken-in via the first opening B1 by the fan 16, and flows via the high-voltage battery 11, the switch module 12 and the battery pack ECU 13, and the power converter 15 in this order. Then, the ambient air thus taken-in is exhausted outside the casing B from the second opening B2.

In this manner, as air can be flown from the high-voltage battery 11 side to the power converter 15 side via the openings B1 and B2 at the wall parts W1 and W2 on both the end sides, the components within the casing can be cooled. Further, as the fan 16 is provided between the high-voltage battery 11 and the opening B1 closer to the high-voltage battery 11, the high-voltage battery 11 weak against heat is cooled preferentially. Consequently, the components within the casing can be cooled efficiently (fifth function).

FIG. 4 is a diagram illustrating a second configuration arrangement within the battery pack 10 according to the second embodiment. As shown in FIG. 4, the battery pack 10 according to the second embodiment further includes shutter members S1 and S2 which close or open the openings B1 and B2 formed at the wall parts W1 and W2 on both the end sides, respectively.

When the components within the casing B are not required to be cooled by the fan 16, the shutter members S1 and S2 respectively cover the openings B1 and B2, whereby possibility of electric leakage and intrusion of foreign matter can be prevented.

In particular, in the second embodiment, the high-voltage battery 11 can also be warmed. Incidentally, as an output of a battery reduces at a low temperature, it is preferable that the warming can be performed at the low temperature. To this end, in the second embodiment, the fan 16 is driven in a state where the openings B1 and B2 are covered by the shutter members S1 and S2, respectively. As a result, air within the casing B can be circulated. It is known that the power converter 15 has a large amount of heat generation. Accordingly, by circulating the air within the casing B, the high-voltage battery 11 can be warmed utilizing heat generated from the power converter 15 in addition to heat generated from the high-voltage battery 11 itself (sixth function).

In such the battery pack 10, the battery pack ECU 13 can exert the fifth and sixth functions by controlling the turning-on and off of the fan 16 and the opening and closing of the shutter members S1 and S2.

Firstly, the battery pack ECU 13 receives the temperature signal from the battery monitor sensor 14 as input. Next, the battery pack ECU 13 determines whether a temperature of the high-voltage battery 11 is a predetermined temperature or more. When determined to be the predetermined temperature or more, each of the shutter members S1 and S2 is opened and the fan 16 is driven. Consequently, ambient air is taken in to cool the high-voltage battery 11 (fifth function).

In contrast, when the temperature of the high-voltage battery 11 is not the predetermined temperature or more, the battery pack ECU 13 determines whether the temperature is a particular temperature or less which is lower than the predetermined temperature. When determined to be the particular temperature or less, each of the shutter members S1 and S2 is closed and the fan 16 is driven. Consequently, air within the casing B is circulated and the high-voltage battery 11 is warmed (sixth function).

In this manner, in the battery pack 10 and the power supply system 1 for a vehicle according to the second embodiment, effect similar to that of the first embodiment can be achieved.

Further, according to the second embodiment, the openings B1 and B2 are respectively formed at the wall parts W1 and W2 on both the end sides of the casing B in the direction coupling the installation position of the high-voltage battery 11 and the installation position of the power converter 15, and the fan 16 is provided between the high-voltage battery 11 and the opening B1 closer to the high-voltage battery 11 within the casing B. Thus, air can be flown from the high-voltage battery 11 side to the power converter 15 side via the openings B1 and B2 at the wall parts W1 and W2 on both the end sides, and hence the components within the casing can be cooled. Further, as the fan 16 is provided between the high-voltage battery 11 and the opening B1 closer to the high-voltage battery 11, the high-voltage battery 11 weak against heat is cooled preferentially. Consequently, the components within the casing can be cooled efficiently.

There are further provided with the shutter members S1 and S2 which close or open the openings B1 and B2 formed at the wall parts W1 and W2 on both the end sides of the casing B, respectively. Thus, when the openings B1 and B2 are respectively covered by the shutter members S1 and S2, air within the casing B can be circulated by the fan 16. As a result, heat generated from the power converter 15 having a large amount of heat generation can be transferred to the high-voltage battery 11 side. Consequently, under environment where the high-voltage battery 11 is too cooled, the high-voltage battery 11 can be warmed and hence the battery can be driven more efficiently.

An explanation has been given of the invention based on the embodiments, but the invention is not limited to the embodiments, and changes may be made or other techniques may be suitably combined in an allowable range, within a scope not departing from the gist of the invention.

For example, in the embodiments, although the battery pack ECU 13 is formed of the single microcomputer, the invention is not limited thereto but the battery pack ECU may be formed of two or more microcomputers.

Further, in the embodiments, although the switch module 12 is provided within the battery pack 10, the invention is not limited thereto but the switch module 12 may be provided outside the battery pack 10.

### DESCRIPTION OF REFERENCE NUMERALS AND SIGNS

1: power supply system for vehicle
10: battery pack
111: high-voltage battery
12: switch module
12a: driving circuit
13: battery pack ECU (control unit)
14: battery monitor sensor (sensor)
15: power converter (step-down circuit)
16: fan
20: charging inlet
30: power control module
31: inverter
40: power management ECU (power-supply system control unit)
B: casing
B1, B2: opening
C: unit cell
F: fuse
IS: current sensor
L1: high-voltage side line
L2: low-voltage side line
M: motor
R: resistor
S1, S2: shutter member
SP: service plug
SR1, SR2: semiconductor relay
W1, W2: wall part

What is claimed is:

1. A battery pack, comprising:
a high-voltage battery which includes a plurality of unit cells which are connected to each other;
a step-down circuit which is disposed between the high-voltage battery and a load, and steps-down voltage applied from the high-voltage battery;
a control unit which executes step-down control so that the step-down circuit performs the step-down; and
a casing which accommodates the high-voltage battery, the step-down circuit and the control unit.

2. The battery pack according to claim 1, further comprising:
a sensor which detects at least one of voltage and temperature of the high-voltage battery and which is disposed in the casing, wherein
the control unit monitors the high-voltage battery based on a signal from the sensor and adjusts the step-down control based on the signal from the sensor.

3. The battery pack according to claim 1, further comprising:
a switch module which electrically conducts or interrupts between the high-voltage battery and the load and which is disposed between the high-voltage battery and the load in the casing, wherein
the control unit executes drive control so as to perform the conduction or interruption at the switch module.

4. The battery pack according to claim 1, wherein the control unit is formed of a single microcomputer.

5. The battery pack according to claim 1, further comprising:
a fan which can blow air and which is disposed in the casing and, wherein
the casing includes openings at wall parts which are respectively on both end sides in a direction coupling an installation position of the high-voltage battery and an installation position of the step-down circuit, and
the fan is disposed between the high-voltage battery and one of the openings closer to the high-voltage battery in the casing and blows the air toward the other opening side.

6. The battery pack according to claim 5, further comprising:
shutter members which close or open the openings at the wall parts on both the end sides of the casing, respectively.

7. A power supply system for a vehicle, comprising:
the battery pack claimed in claim 3; and
a power-supply system control unit which transmits a signal to set the switch module to be conductive or interruptive to the control unit in the battery pack.
